(19) United States
(12) Patent Application Publication
(10) Pub. No.: US 2002/0028103 A1
(43) Pub. Date: Mar. 7, 2002

(54) Paint applicator

(76) Inventors: Peter L. Frank, Hamel, MN (US); Terry R. Reents, Burnsville, MN (US); Victor Jon Fageroos, Woodbury, MN (US); Jeffrey S. Jerdee, Brooklyn Center, MN (US); Steven A. Anderson, Eden Prairie, MN (US)

Correspondence Address: PATTERSON, THUENTE, SKAAR & CHRISTENSEN, P.A., 4800 IDS CENTER, 80 SOUTH 8TH STREET, MINNEAPOLIS, MN, 55402-2100, US

(21) Appl. No.: 09/928,665

(22) Filed: Aug. 13, 2001

Related U.S. Application Data
(60) Provisional application No. 60/225,110, filed on Aug. 14, 2000.
(60) Provisional application No. 60/226,960, filed on Aug. 22, 2000.

(51) Int. Cl. B43K 8/20

(52) U.S. Cl. 401/197; 401/208

(57) ABSTRACT

A paint applicator for use in spreading paint over a surface. The paint applicator includes a roller assembly, tubing, and a pump assembly. The roller assembly has a handle portion that is suitable for holding by a user, an arm portion extending from the handle portion, and a roller core removably attachable to the arm portion for rotation with respect to the arm portion. The roller core is adapted to receive a paint applicator thereover. The tubing has a central passage extending therethrough. The pump assembly conveys paint through the tubing to the roller assembly. A method and a corner paint applicator are further included.

### REFERENCE TO RELATED APPLICATIONS

The present application claims priority to U.S. Provisional Application No. 60/225,110, which was filed on Aug. 14, 2000, and U.S. Provisional Application No. 60/226,960, which was filed on Aug. 22, 2000, which are both incorporated herein in their entirety by reference.

### SUMMARY OF THE INVENTION

The present invention generally relates to a paint applicator. More particularly, the present invention relates to a paint applicator wherein the paint is propelled mechanically, as distinct from being propelled by air.

### BACKGROUND OF THE INVENTION

To enhance the ease of painting various painting devices have been developed. Many painting devices typically rely on compressed air to move the paint from a paint storage container to a surface where the paint is to be applied.

A significant drawback of these types of painting devices is that they require an air compressor to be in close proximity to the surface where the paint is to be applied. Air compressors are typically quite bulky and, as such, do not readily lend themselves to painting relatively small surfaces like are found in most households.

To overcome these drawbacks mechanical paint applicators have been developed. Mechanical paint applicators typically include a painting head, a purnp and tubing that extends from a paint container to the pump and further to the painting head. Pumps used in mechanical paint applicators typically may have a piston pump, a peristaltic pump or other type of pump. The pumps that have a peristaltic configuration have the advantage of allowing the tubing to extend continuously from the paint reservoir through the pump to the paint head. The pump never comes in direct contact with the paint, thereby minimizing the potential contamination of the pump by the paint.

When finished painting with a particular color or when the end of a workday approaches, the painting head and the tubing must either be cleaned or discarded. Since these components are not inexpensive, it is often preferable to clean rather than discard the components. While cleaning is an important task, it is time consuming because large amounts of cleaning fluid such as water or other solvents, such as mineral spirits, must be pumped through the mechanical paint applicator in order to fully flush the paint from the applicator.

What is needed is a paint applicator that is easily carried as a unit along with a paint container during use. It is also needed to produce a paint applicator that is stable during use to minimize paint spills associated with tipping of the paint applicator. It is further needed to produce a paint applicator that promotes even paint application and is easily cleanable after use is completed without the use of an air compressor.

### SUMMARY OF THE INVENTION

The present invention substantially meets the aforementioned needs by providing a paint applicator for use in spreading paint over a surface. The paint applicator includes a roller assembly, tubing, and a pump assembly. The roller assembly includes a handle portion that is suitable for holding by a user, an arm portion extends from the handle portion, and a roller core removably attachable to the arm portion for rotation with respect to the arm portion. The roller core is adapted to receive a paint applicator thereover. The tubing has a central passage extending therethrough. The pump assembly conveys paint through the tubing to the roller assembly.

The present invention also relates to the operation of a paint applicator. The method includes operably connecting a roller assembly to a pump assembly with tubing. The pump assembly has a feed line extending therefrom. The feed line is operably connecting to a paint source. The pump assembly is activated for a first period of time by depressing a button that is operably connected to the pump assembly. The pump assembly causes paint to be passed through the pump assembly and the tubing to the roller assembly. The pump assembly remains activated when the button is released. The pump assembly is activated for a second period of time by depressing the button in a press and hold mode of operation. The pump assembly deactivates when the button is released. The roller assembly is rolled along a surface to at least partially cover the surface with the paint.

### BRIEF DESCRIPTION OF THE DRAWINGS

FIG. 1 is a perspective view of a paint applicator of the present invention;

FIG. 2 is a sectional view of the roller assembly;

FIG. 3 is a side elevational view of an arm portion of the roller assembly;

FIG. 3a is a side elevational view of an alternative embodiment of the distribution section of the arm portion;

FIG. 4 is a perspective view of an end cap;

FIG. 5 is a side view of a roller core of the roller assembly;

FIG. 5a is a sectional view of the roller core taken along the section line 5a-5a of FIG. 5;

FIG. 5b is a side elevational view of the roller core coupling portion;

FIG. 6 is a perspective view of an adaptor for use with the roller core;

FIG. 7 is a side view of a handle portion of the roller assembly;

FIG. 8 is a sectional view of the handle portion taken along a line 8-8 in FIG. 7;

FIG. 9 is a sectional view of the handle portion taken along a line 9-9 in FIG. 7;

FIG. 10 is a perspective view of a handle portion connection mechanism;

FIG. 10a is a side elevational view of the coupling flange;

FIG. 11 is a perspective view of the pump assembly with a top cover removed;

FIG. 12 is a sectional view of the pump assembly taken along a line 12-12 in FIG. 11;

FIG. 13 is a sectional view of the pump assembly depicting a first side of the end cap and taken along a line 13-13 in FIG. 12;

FIG. 13a is an elevational view of the opposing side as depicted in FIG. 13, side of the end cap that faces the motor;

FIG. 14 is a sectional view of the pump assembly taken along a line 14-14 in FIG. 12;

FIG. 15 is a sectional view of the pump assembly taken along a line 15-15 in FIG. 12;

FIG. 16 is a schematic illustration of a control system for the paint applicator;

FIG. 17 is a more detailed schematic of the control system of FIG. 16;

FIG. 18 is a perspective view of an alternative embodiment of the paint applicator of the present invention;

FIG. 18a is a perspective view of the roller cover;

FIG. 19 is a perspective view of a pump assembly for the paint applicator of FIG. 18;

FIG. 20 is a perspective view of a corner applicator;

FIG. 21 is a side elevational view of the corner applicator body;

FIG. 22 is a top planform view of the corner applicator body;

FIG. 23. is a rear perspective of the corner applicator body taken in a plane that is orthogonal to the longitudinal axis of the holder;

FIG. 24 is a rear perspective view of the corner applicator body taken in a plane that is parallel to the longitudinal axis of the holder;

FIG. 25 is a sectional view of the corner applicator body taken along the section line A-A of FIG. 24;

FIG. 26 is a planform view of applicator pad; and

FIG. 27 is side elevational view of the applicator pad.

### DETAILED DESCRIPTION OF PREFERRED EMBODIMENTS

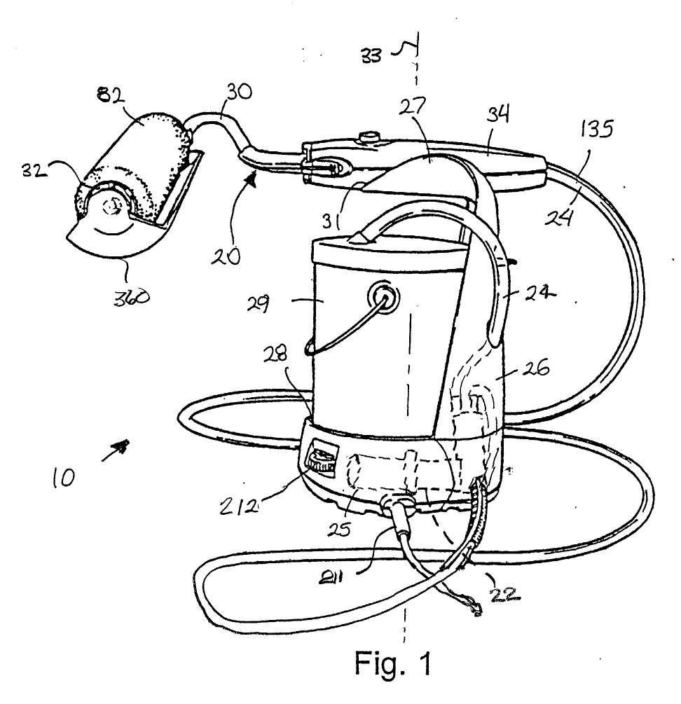

The present invention is a paint applicator for applying paint, as most clearly illustrated at 10 in FIG. 1. The paint applicator 10 generally includes a roller assembly 20 and a pump assembly 22 that are interconnected with tubing 24.

The pump assembly 22 has a pump housing 25, a side support 26 and a handle 27. The pump housing 25 not only provides space for a pump 31 (described in more detail herein) but also has a substantially circular top surface 28 defining a receiver in which a paint container 29 may be placed and supported. The side support 26 extends upwardly from the pump housing 25 adjacent to a side of the paint container 29.

The pump assembly 22 is oriented substantially beneath the paint container 29 with the mass of the pump assembly 22 concentrated directly beneath the paint container 29 such that a central axis 33 of the pump assembly 22 about which the pump assembly 22 is balanced is proximate to a central axis of the paint container 29 when the paint container 29 is placed on the top surface 28. This configuration provides the pump assembly 22 with a high degree of stability whether the paint container 29 is full or empty so that it is unlikely for the pump assembly 22 (and paint container 29) to be inadvertently knocked over. Even though the paint container 29 is covered with a lid 33, paint may still spill from the paint container 29 if the pump assembly 22 were to be knocked over and the highly stable design of the present invention minimizes the chance of this occurring.

A handle 27 is attached to the upper margin of the side support 26 opposite the pump housing 25. The handle 27 at least partially extends over the lid of the paint container 29 and is spaced apart from the container 29 and thereby enables the paint applicator 10 and the paint container 29 to be carried as a unit. The handle 27 also preferably has a channel 31 formed therein. The channel 31 is adapted to receive the roller assembly 20 therein, substantially as depicted in FIG. 1, partially enclosing the roller assembly 20 within the channel 31 to further facilitate carrying the components of the paint applicator 10 as a single unit. An operator may grasp the handle 27 and the partially enclosed roller assembly 20 with a single hand to transport the paint applicator 10 and the paint container 29 as a single unit.

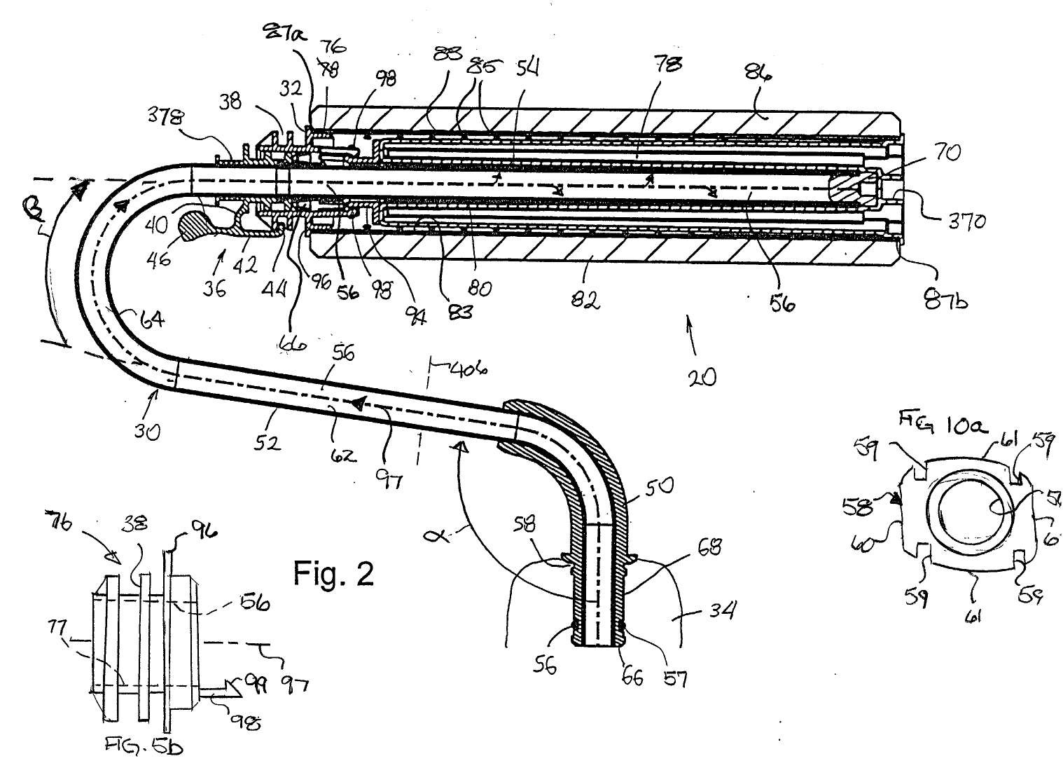

A significant feature of the present invention is that the roller assembly 20 (see FIG. 2) enables the roller core 32 to be easily and quickly separated from the arm portion 30 to readily facilitate changing or cleaning the roller core 32 (and applicator 82) by means of a readily releasable locking mechanism 36, described in more detail below. Changing or cleaning the roller core 32 (and applicator 82) is required when changing the color of paint to prevent contamination of the various paint colors and the locking mechanism 36 of the present invention readily accommodates what in other designs is a thoroughly messy and objectionable task.

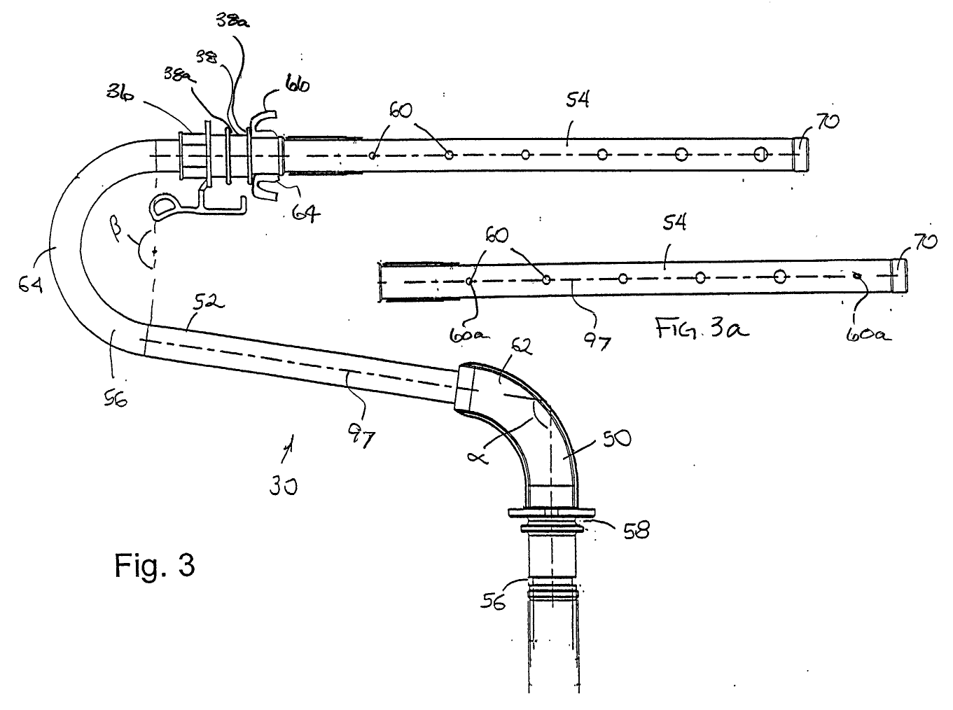

Specifically, the roller assembly 20 includes an arm portion 30, the roller core 32 (supporting an applicator 82), and a handle portion 34, as most clearly illustrated in FIGS. 2-10. The arm portion 30 includes the locking mechanism 36 that seats within a circumferential channel 38 on the roller core 32. The engagement section 44 of the locking mechanism 30 rides loosely in the channel 38 with a certain amount of play between the spaced apart ridges 38a (see FIG. 3) that define the sides of the channel 38. Accordingly, the locking mechanism 36 retains the roller core 32 on the arm portion 30 while at the same time permitting the roller core 32 to rotate with respect to the arm portion 30.

The locking mechanism 36 generally includes a central section or hinge 40, a top section 42, an engagement section 44, and an activation section 46. The central section 40 is attached to and extends outwardly from the arm portion 30. The top section 42 is attached substantially orthogonally to the central section 40 generally parallel to the arm portion 30 so that the central section 40 is approximately intermediate the engagement section 44 and the activation section 46. A lip of the engagement section 44 preferably extends from the top section 42 towards the arm portion 30 so that the engagement section 44 may seat loosely within the channel 38. The activation section 46 is attached to an end of the top section 42 opposite the engagement section 44.

Manual force on the activation section 46 directed generally toward the arm portion 30 causes the top section 42 to pivot so that the engagement section 44 moves away from the arm portion 30 until the engagement section 44 is not seated within the channel 38. This pivoting movement permits the roller core 32 to then be separated from the arm portion 30 by sliding the roller core 32 away from the arm portion 30.

The arm portion 30 also includes a connector section 50, a main section 52, and a distribution section 54, as most clearly illustrated in FIGS. 2 and 3. The connector section 50, the main section 52 and the distribution section 54 each have a central passage formed therein to define a continuous passage 56.

The arm portion 30 is preferably fabricated from a metallic tube to provide the arm portion 30 with sufficient structural rigidity to resist bending during use. A person of ordinary skill in the art will appreciate that it is also possible to fabricate the arm portion 30 from alternate materials, such as for example, plastic material.

The connector section 50 allows the arm portion 30 to be removably attached to the handle portion 34. The connector section 50 preferably includes a circumferential channel 56 formed therein that is adapted to receive an O-ring 57 to enhance a seal between the arm portion 30 and the handle portion 34. Proximate an upper end of the connector section 50, the connector section 50 has a coupling flange 58 extending therefrom. The flange 58 is adapted to receive a locking mechanism as will be described in more detail below. The coupling flange 58 (see also FIG. 10a) has four indents 59 and two opposed flat sides and two opposed curved sides 61.

The configuration of the connector section 50 provides a stepped diameter such that when the arm portion 30 is being attached to the handle portion 34, the O-ring engages the handle portion 34 near the end of travel. In this configuration a first bearing surface 66 has a first diameter and a second bearing surface 68 has a second diameter that is greater than the first diameter. An advantage of this configuration is that it promotes guiding the handle portion 34 into engagement with the arm portion 30 while minimizing the potential for paint to leak from between the components.

Referring to FIG. 2, the main section 52 has a first angled region 62 and a second angled region 64 to thereby allow the roller core 32 to be oriented substantially perpendicular to the handle portion 34. The first angled region 62 preferably has an angle a of between about 80 and 120 degrees and preferably about 98 degrees. The second angled region 64 preferably has the complement of an angle β, the complement being between 150 and 210 degrees and preferably about 172 degrees.

The distribution section 54 extends through the center of the roller core 32 and has a plurality of apertures 60 formed therein. The distribution section 54 substantially extends the entire length of the applicator 82. The applicator 82 typically has cylindrical core 83, usually made of a stiff paper or plastic material, having many holes 85 formed therethrough to transport paint outward to flood the nap 86 for application to a surface. The distribution section 54 thereby provides a bearing surface 87a, 87b supporting the respective ends of the applicator 82 to minimize bending of the distribution section 54. Such bending, were it to occur, may lead to a condition referred to as coning where the nap 86 becomes unevenly compressed along the length of the applicator 82 and leads to uneven application of paint on a surface.

The distribution section 54 thereby permits paint to flow from the central passage 56 to the roller core 32 through apertures 60 defined in the distribution section 54 to the applicator 82 To enhance the even distribution of paint on the roller assembly 20, the apertures 60 in a first embodiment depicted in FIG. 3 preferably increase in size moving along the paint flow path, the greatest size being closest to the distal end of the distribution section 54. The size and number of the apertures 60 are selected based upon a variety of factors such as the viscosity of the paint and the length of the roller core 32. In the embodiment of FIG. 3a, the two end apertures 60a are formed of substantially the same size. The arrangement and sizing of the apertures 60, 60a of this embodiment have the advantage of more evenly distributing the delivery of relatively more viscous paint.

A lip seal 66 is disposed at the proximal end of the roller core 32 (see FIG. 3). The lip seal 66 is preferably formed of a resilient rubber or plastic material and has a cylindrical engaging portion 66 that snuggly engages the outer margin of the locking mechanism 36. A generally cylindrical sealing lip portion 65 extends outward relative to the engaging portion 66 and projects toward the distribution section 54. In assembly, the outer margin of the lip portion 65 sealingly engages an inner diameter 77 of the core coupling portion 76 (described in greater detail below) to define a fluid-tight seal between the arm portion 30 and the roller core 32.

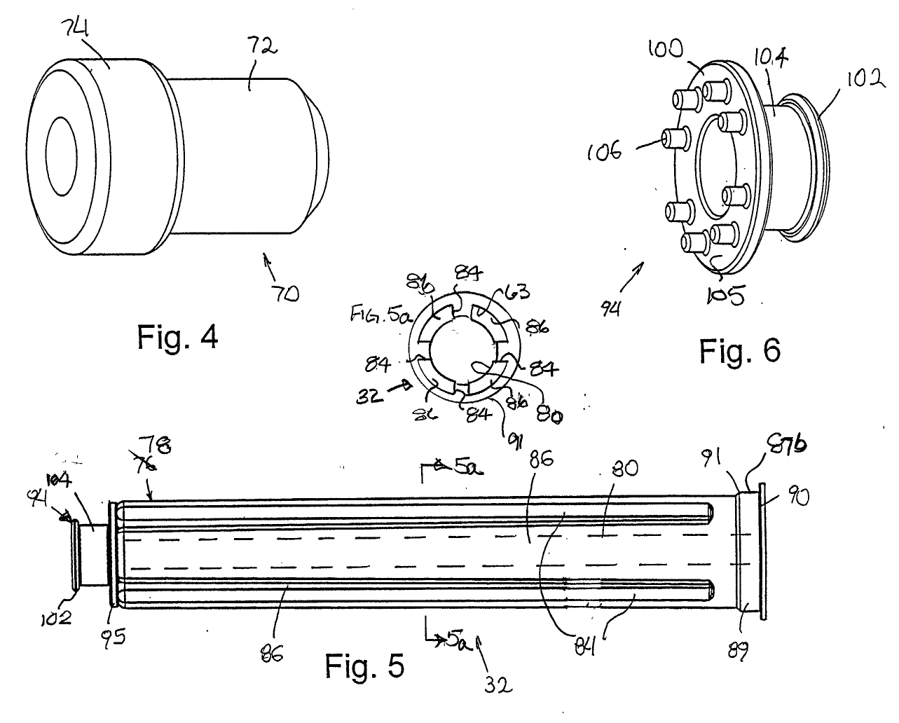

The roller assembly 20 also includes an end cap 70, as most clearly illustrated in FIG. 4. The end cap 70 includes a main portion 72 and a cap portion 74. The main portion 72 is adapted to seat in an end of the distribution section 54 opposite the main section 52 to thereby prevent paint from passing out of the distribution section 64 except through the apertures 60. The cap portion 74 preferably has a diameter that is approximately equal to a diameter of the distribution section 54.

The roller core 32 preferably has a coupling portion 76 and a paint distribution portion 78, as most clearly illustrated in FIGS. 2 and 5-5b. The roller core 32 includes a central passage 80 through which the distribution section 54 may extend. One of the primary functions of the roller core 32 is to displace volume within the roller assembly 20 to thereby minimize the amount of paint in the roller assembly 20. Referring to FIG. 5a, apertures 84 are preferably elongate slots formed in the roller core 32 between semi-circular passage elements 61 and extending substantially the full length of the roller core 32. It should be noted that the elements 61 may be formed hollow, having a sealed interior space 63 defined therein to reduce the potential volume that may be filled with paint. By reducing the amount of paint in the roller assembly 20, the roller core 32 minimizes wasted paint, reduces the weight borne by the user, and facilitates cleaning of the roller assembly 20. The apertures 84 are disposed in a spaced-apart relationship so that spacing between adjacent apertures 84 is approximately equal.

The roller core 32 is adapted to receive the paint applicator or roller 82 over an outer surface thereof such that the roller core 32 seats in an annular channel 83 formed in the paint applicator 82. The paint applicator 82 is removably retained between the coupling portion 76 and the distal end of the paint distribution portion 78.

To retain the applicator 82 in a fixed position with respect to the roller core 32, the roller core 32 also preferably includes a lip 90 defined on an end cap 91 that extends from an outer end thereof. The outside margin 87b sealingly engages the inside diameter of the paint applicator 82 to prevent paint leakage and support the paint applicator 82.

The adaptor 94 (see FIG. 6) releasably cooperates to connect the coupling core portion 76 to the paint distribution portion 78, as most clearly illustrated in FIG. 2. The adaptor 94 includes a top flange 100, a bottom flange 102 and a main body portion 104 that extends between the top flange 100 and the bottom flange 102, as most clearly illustrated in FIG. 6.

The top flange 100 may have a plurality of pins 106 extending therefrom. The pins 106 extend through apertures (not shown) formed in an end 95 of the first core portion 76. The pins 106 are arranged to correspond with the position of the apertures. Alternatively, the face 105 may be smooth and the adapter 94 may be adhered to the end margins of the semi-circular elements 61, as by bonding, welding or the like.

Referring to FIG. 5b, the coupling portion 78 has a lip 96 extending radially outward. The coupling portion 76 also includes a plurality of resilient snap fingers 98 extending parallel to the flow axis 97 in the direction of flow. A single finger 98 is depicted in FIG. 5b, but preferably there are many (8-16 preferably) such arms arranged circumferentially and radially outward of the flow channel 56 defined in the coupling portion 76 The resilient fingers 98 include inward directed barbs 99 that, in operation, ride over and engage the lip 102 of the adaptor 94 to retain the distribution portion 78 in a fixed position with respect to the coupling portion 76. Grasping the applicator 82 and pulling sharply away from the coupling portion 76 causes the fingers 98 to flex and the barbs 99 to spread radially and ride over the lip 102, thereby serving to disengage the distribution portion 78 (and the applicator 82) from the coupling portion 76. The resilient snap fingers 98 advantageously eliminate the threaded engagement common in the prior art.

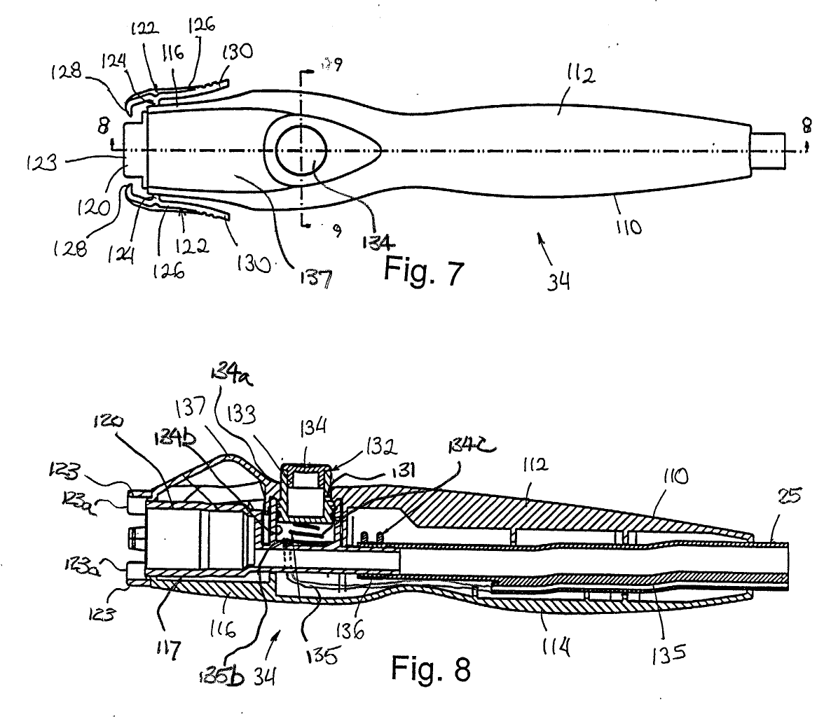

The handle portion 34 is depicted generally in FIG. 1 and in more detail in FIGS. 7-10. The handle portion 34 preferably has an outer margin 110 the rear portion of which is contoured (rounded and tapered) to provide a handle conforming with the shape of a user's hand, as most clearly illustrated in FIGS. 7 and 8. The handle portion 34 is preferably molded in a two-part configuration having a top portion 112 and a bottom portion 114 that mate together.

The handle portion 34 has a connection mechanism 120 proximate an upper end 116 of the handle portion 34 where the handle portion 34 intersects the arm portion 30, as depicted in FIG. 1. The connection mechanism 120 may be formed separate from the portions 112, 114 and seated in a receiving aperture 117 defined in the handle portion 34. The connection mechanism 120 not only provides a connection between the handle portion 34 and the arm portion 30 but also houses a mechanism for operably controlling the flow of paint from the pump assembly 22 to the roller assembly 20.

The connection mechanism 120 includes a locking mechanism 122 that is designed to releasably engage the coupling flange 58 (see also FIG. 10a) of the arm portion 30. The locking mechanism 122 thereby retains the handle portion 34 on the arm portion 30. As indicated above, the coupling flange has four indents 59 and two opposed flat sides 60 and two opposed curved sides 61. Two opposed semi-circular ends 123 of the connection mechanism 120 preferably extend over the two opposed curved sides 61 and depending tabs 123a on either end of the respective semi-circular ends 123 slide into and engage a respective indent 59 to assist in aligning the handle portion 34 with the roller assembly 20. The semi-circular ends 123 also serve to protect the two locking mechanisms 122 from damage if the handle portion 34 is dropped.

A quick disconnect locking mechanism 122 is disposed on respective sides of the handle 34 in an opposed arrangement. The locking mechanism 122 is preferably formed integral with the connecting mechanism 120. The locking mechanism 122 is preferably formed of a plastic material and is molded integral with the connecting mechanism 120. Each locking mechanism 122 generally includes a central hinge section 124, a top section 126, an engagement section 128, and an activation section 130, as illustrated in FIGS. 7 and 10. The central section 124 is attached and is outwardly directed relative to the connection mechanism 120, as most clearly illustrated in FIGS. 8 and 10. The top section 126 is attached to the central section 124 opposite the connection to the connection mechanism 120 so that the central section 124 is approximately intermediate the engagement section 128 and the activation section 130. The engagement section 128 is curved inward so that the engagement section 128 may extend around a respective opposed flat sides 60 of the flange 58 to releasably couple to the flange 58. The resilient hinge section 124 biases the locking mechanism into engagement with the flange 58. The activation section 130 is attached to an end of the top section 126 opposite the engagement section 128.

Manual, inward directed force on the activation section 130 causes the top section 126 to pivot about the hinge 124 so that the engagement section 128 moves away from the connection mechanism 120 until the engagement section 128 is not extend around the flange 58. This pivoting movement permits the arm portion 30 to be separated from the handle portion 34 by sliding the arm portion 30 away from the handle portion 34.

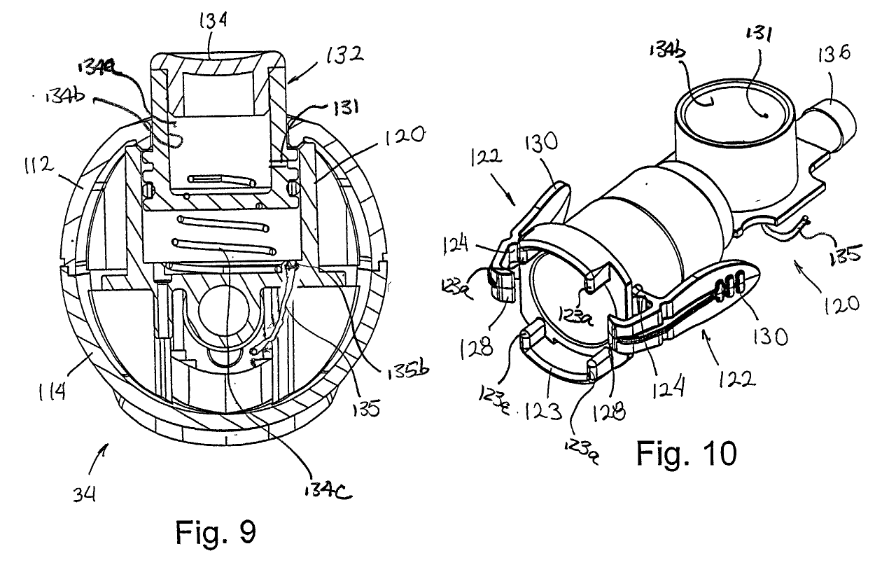

The connection mechanism 120 also includes a flow control mechanism 132 that controls the flow of paint from the pump assembly 22 to the roller assembly 20, as illustrated in FIGS. 8 and 9. The flow control mechanism 132 used in conjunction with the paint applicator 10 of the present invention is preferably an air-based system that eliminates hazards associated with electrocution that are associated with electrical control systems.

The flow control mechanism 132 preferably includes an air signal generator 133 in the handle portion 34 and a corresponding air signal receiver 222 in the pump base 22, which is operably connected to the motor 150. The air signal generator 133 in the handle portion 34 is vented by a small vent bore 131 to the atmosphere to minimize potentially detrimental effects on the control of the paint applicator 10 caused by changes in barometric pressure and ambient temperature.

The air signal generator 133 and the pump air signal receiver 222 are operably connected with an air tube 135. The air tube 135 is in fluid communication with the cylinder 134b by means of a small bore 135a defined through the base of the cylinder wall. The air tube 135 is preferably integrally molded with the tube 24 through which the paint flows. The diameter of the air tube 135 is substantially smaller than a diameter of the tube 24. This configuration minimizes the amount of air that must flow through the air tube 135 to activate the air signal receiver 222 to control the motor 150 in the pump base 22.

The air signal generator 133 preferably includes a button 134 that is depressed with manual pressure to generate an air pressure signal. The button is preferably the top portion of a piston 134a that is translatably disposed in the cylinder 134b. A spring 134c biases the piston 134a against the manual pressure exerted to activate the air signal generator 133. When the button 134 is depressed, a pulse of air pressure flows through the air tube 135 and activates air signal receiver 222 to control the motor 150 in the pump base 22. The flow control mechanism 132 thereby commences and terminates paint flow through the connection mechanism 120.

Adjacent the button 134, the handle portion 34 preferably includes an elevated region 137, as most clearly illustrated in FIG. 8. The elevated region 137 extends above the button 134. The elevated region 137 thereby prevents activation of the switch 133 if the handle 34 is laid on a surface with the switch 133 facing downwardly.

Proximate a lower end of the connection mechanism 120, a cylindrical portion 136 extends therefrom. The cylindrical portion 136 preferably has a plurality of ridges (not shown) extending from an outer surface thereof to facilitate connection of the tubing 24 to the cylindrical portion 136.

Referring to FIG. 1, the pump assembly housing 25 provides an aesthetically appealing cover for the pump assembly 22 and supports the paint container 39. The pump assembly housing 25 preferably includes a substantially flat top surface 28 that is preferably 20 shaped to conform to a shape of a one-gallon paint container 39, as most clearly illustrated in FIG. 1. The pump assembly housing 25 is designed to accept substantially all commonly available one-gallon paint containers. The pump assembly 22 may also include a strap (not shown) to attach the paint container 29 to the pump assembly housing 25.

The pump assembly 22 also includes a side portion 26 that encloses the pump head 152, as will be described herein. The side portion 26 preferably has a curved inner surface that is shaped to substantially conform to an outer surface of the paint container 39. The outer surfaces of the pump assembly housing 25 preferably have smooth curved contours to enhance the aesthetic appeal of the pump assembly housing 25.

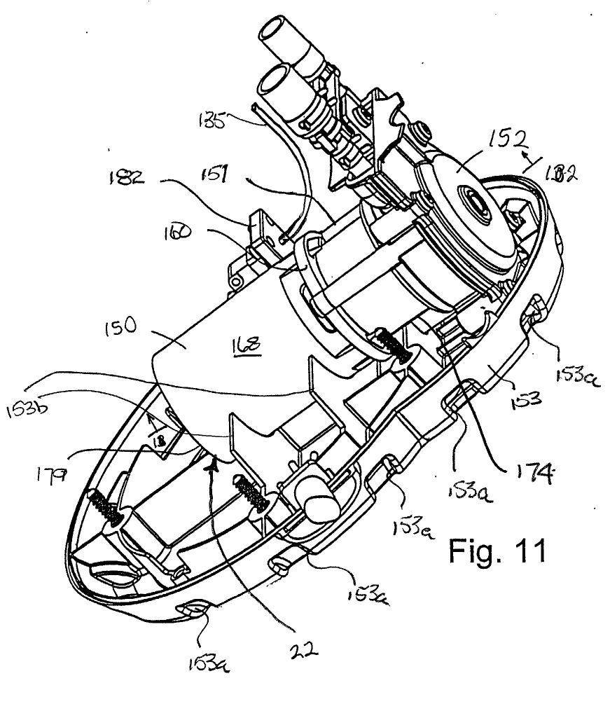

Inside of the pump assembly housing 25 is the pump assembly 22, including the motor 150, the transmission 151, and the pump head 152, as most clearly illustrated in FIG. 11. The pump assembly 22 is supported on a housing base 153, couplable to the housing 25, preferably by means of screws. The motor 150 and the transmission 151 are positioned in a substantially horizontal orientation such that the motor 150 and transmission 151, which together are one of the most dense components of the paint applicator 10, are positioned beneath the paint container to keep the center of gravity of the paint applicator 10 as low as possible and to thereby stabilize the paint applicator 10 and reduce the likelihood that the paint applicator 10 will tip over during use.

The motor 150 is preferably a permanent magnetic DC motor that is operated by electrical current. A person of ordinary skill in the art will appreciate that the size of the motor 150 is selected based upon the size and type of tubing 24 as well as the desired paint flow rates. Moreover, while a person of ordinary skill in the art will appreciate that the concepts of the present invention may be utilized with alternative motor and power source configurations, the mating of a permanent magnet DC motor to a peristaltic pump is believed to be unique to the present invention.

The motor 150, transmission 151, and the pump head 152 and the associated components are oriented in an in-line configuration. The motor 150 does not tolerate axial loading well. Accordingly, a screw 153 (or alternatively a smaller head screw acting on a large washer) is threaded into the axial output shaft and the head bears a portion of the surrounding housing to substantially eliminates axial loading on the motor 150.

The components of the pump assembly 22 are preferably integrally mounted within an enclosure 174 to minimize the potential for misalignment of the motor 150, the transmission 151 and the components in the pump head 152.

All of the components in the pump assembly 22 are fabricated with as great a content of light weight plastic as possible, which provides the pump assembly 22 with a relatively light weight. Such a configuration is particularly desirable so that persons using the paint applicator 10 of the present invention may lift the pump assembly 22 and the paint container 29 to be carried as a unitary configuration.

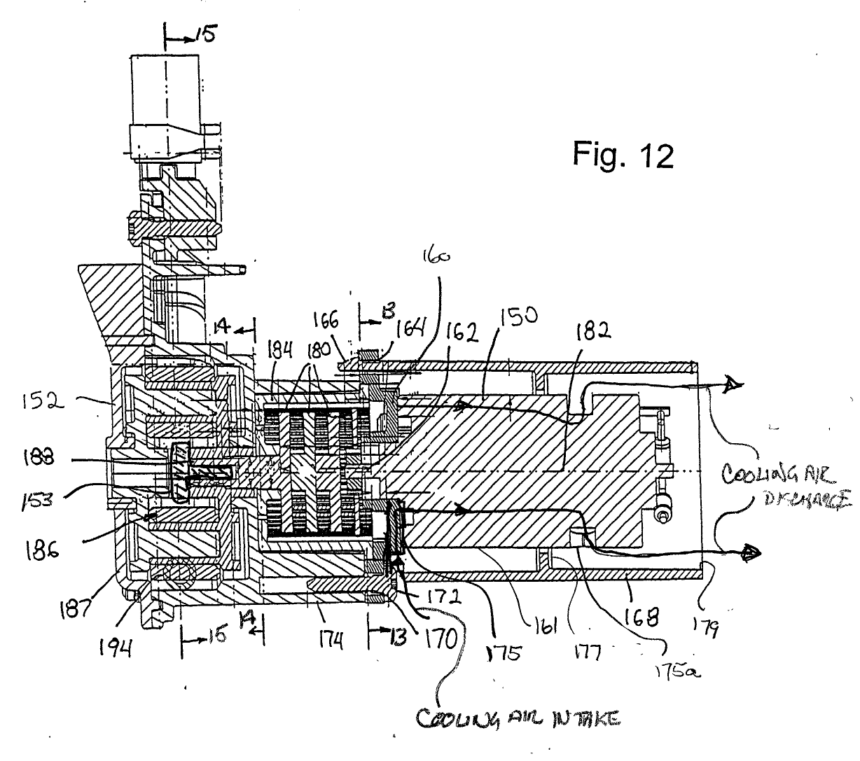

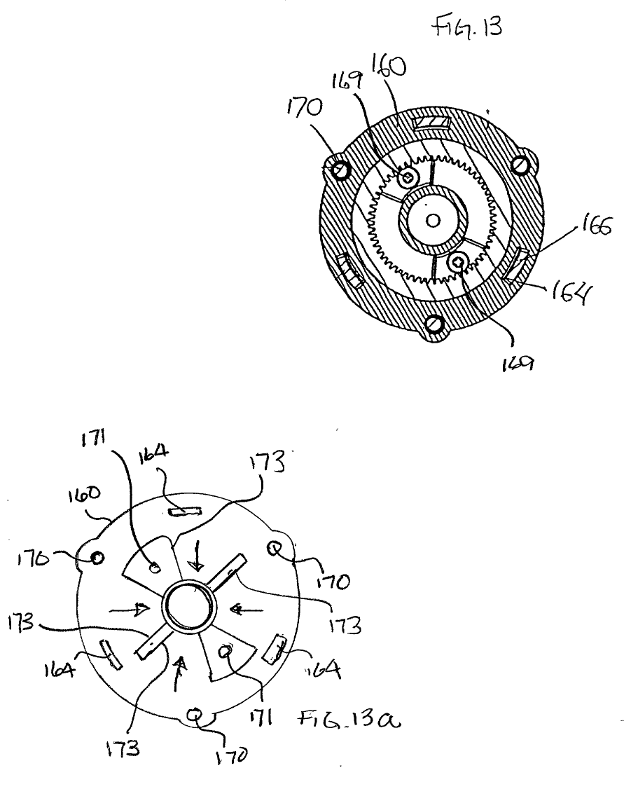

Referring to FIGS. 12, 13, and 13a, an end plate 160 is attached to an end of the motor 150 from which the shaft 162 extends. The end plate 160 has a plurality of slots 164 formed therein. The slots 164 are each adapted to receive a tab 166 extending from a motor cover 168. The interconnection between the tabs 166 and the slots 164 thereby enable the motor cover 168 to be removably attached to the end plate 160.

The end plate 160 also has a plurality of apertures 170 formed therein. The apertures 170 are each adapted to receive a bolt 172, which also threadably engages a pump head enclosure 174 by extending into an aperture 176 formed therein. The end plate 160 thereby removably attaches the motor 150 to the pump head 152. Oppositely directed screws 169 pass through bores 171 and are screwed into the housing 161 of the motor 150, thereby effecting a fixed coupling of the motor 150 to the transmission 151.

The cover 168, referred to above, performs several functions. First, it is formed of a self extinguishing material to minimize any fire hazard from the motor 150. Further, the cover plays a role in cooling the motor 150. Cooling the motor 150 is a critical function and a unique cooling flow has been devised. Four converging channels 173 are formed on the surface of the end plate, as depicted in FIG. 13a. The channels direct cooling air radially inward as indicated by the four arrows. The air flow then turns substantially ninety degrees to flow out of the paper, as depicted in FIG. 13a, and to enter a respective intake aperture 175 defined in the end of the housing 161, as depicted by the arrow in FIG. 12. The cooling air flows axially through the housing 161, cooling the various components of the motor 150 and exits through aperture 175a defined in the side wall of the housing 161. A plurality of circumferentially spaced apertures 175a may used. The cooling air also picks up any small particles generated though friction in the rotating motor 150. A circumferential baffle 177, preferably formed integral with the cover 168, prevents the expelled (now heated) cooling air and any entrained particles from reversing direction and reentering the housing 161 through the apertures 175. Accordingly, the exhausted, heated cooling air (and any entrained particles) is discharged through the open end 179 of the cover 168. Vents 153a (see FIG. 11) formed in the base 153 provide for the discharge of heated cooling air and the introduction of relatively cool ambient air for the cooling of the motor 150. Baffles 153b act to further isolate the incoming cool air from the discharged heated air by being positioned intermediate the cooling air inlet (proximate the end plate 160 as indicated above) to the motor 150 and the heated air discharge through the opening 179.

The transmission 151 preferably includes three planetary gear assemblies 180 that reduce the revolutions per minute and amplify the torque provided by the motor 150, as most clearly illustrated in FIG. 12. Each of the planetary gear assemblies 180 is preferably located along the horizontal central axis 182. The components used in each of the planetary gear assemblies 180 are each substantially identical to reduce manufacturing costs. The planetary gear assemblies 180 are each located within an interior housing 184. The planetary gear assemblies 180 and the housing 184 are both preferably seated within the pump head enclosure 174.

A peristaltic pumping mechanism 186 seats within the pump head enclosure 174 opposite the planetary gear assemblies 180. The pump head 152 also includes a pump head cover 187 that seats against the pump head enclosure 174 to substantially seal the peristaltic pumping mechanism 186 therein. The pump head cover 187 is preferably secured to the pump head enclosure 174 with a plurality of screws 189. The screws 189 permit the peristaltic pumping mechanism 186 to be accessed to perform maintenance such as replacement of the pump head tube 198. One situation where it is desirable to change the size of the pump head tube 198 is when it is desired to user a different diameter tube 198 in the pump head 152. Changing the inner diameter of the pump head tube 198 allows the pumping rate of the pump assembly 22 to be changed without changing any other system components.

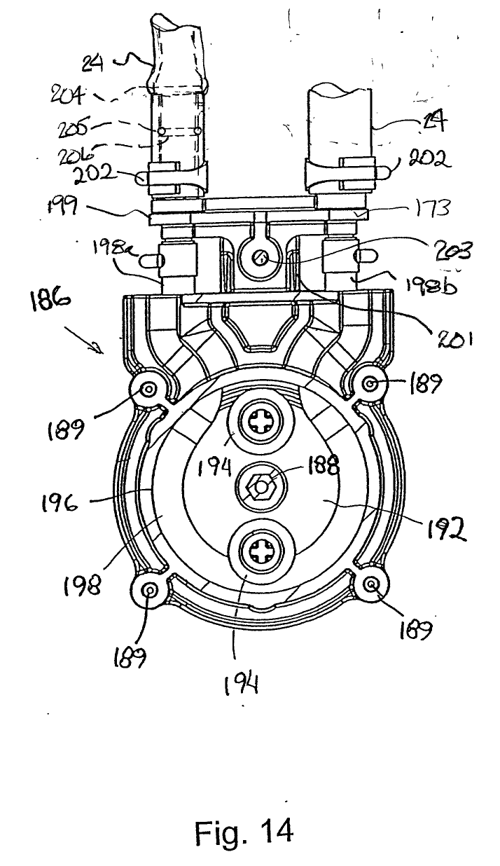

The peristaltic pumping mechanism 186 engages a shaft 188 extending from the last planetary gear assembly 180, as most clearly illustrated in FIGS. 12 and 14. The shaft 188 preferably has a hexagonal profile such that the shaft 188 can extend into a complementarily shaped aperture 190 in a base portion 192 of the peristaltic pumping mechanism 186. The mating relationship of the shaft 188 and the base portion 192 thereby permits the base portion 192 to slide along the central axis 182 with respect to the shaft 188. This configuration thereby minimizes the thrust of the peristaltic pump head 186 on the associated gear assembly and the motor 150. However, the shaft 188 is not a bearing surface, which minimizes detrimental effects on the shaft 188 such as degradation caused by wearing down on the surfaces of the shaft 188.

The peristaltic pumping mechanism 186 also includes a pair of rollers 194 that are rotatably attached to the base portion 192, as most clearly illustrated in FIGS. 12 and 14. Each of the rollers 194 is rotatable about an axis that is parallel to but offset from the central axis 182.

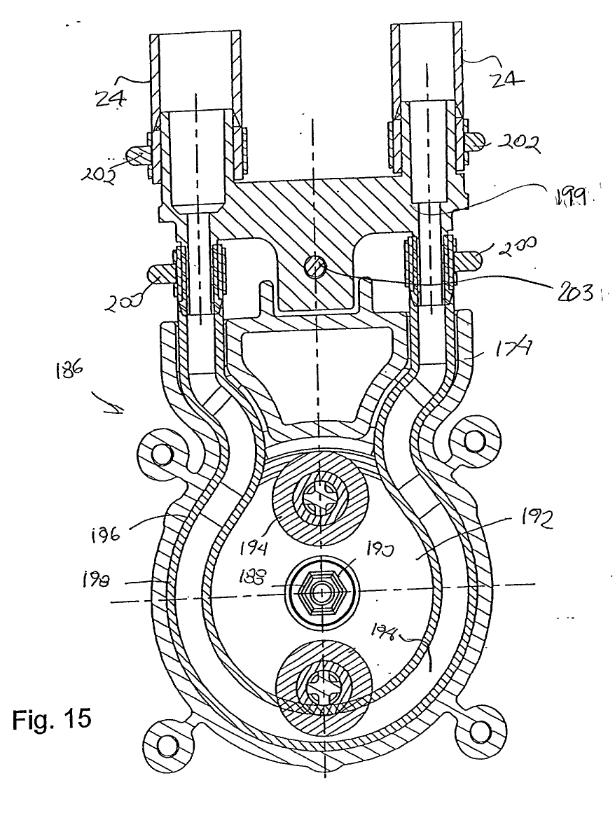

The peristaltic pumping mechanism 186 includes a pathway 196 that is adapted to receive the pump head tube 198 through which the paint is to be pumped, as most clearly illustrated in FIGS. 12 and 15. The pump head tube 198 is fabricated from a resilient material that permits the pump head tube 198 to collapse when contacted by the rollers 194 but that also substantially returns to its initial round configuration when not contacted by the rollers 194.

Opposite ends 198a, 198b of the pump head tube 198 are secured to the pump manifold (H-shaped fitting) 199 with clamps 200. The manifold 199 is affixed to the peristaltic pumping mechanism 186 by means of a screw 203 passing through a bore defined in the manifold 199 and thence into an upward directed flange 201 formed integral with the he peristaltic pumping mechanism 186 The tubing 24 extending from the paint container 29 and to the roller assembly 20 is attached to the pump head enclosure 174 with clamps 202 so that the tubing 24 is in fluid communication with the pump head tube 198. Especially where the tubing 24 is formed of a vinyl or a vinyl-like material, a lip 204 over which the tubing 24 must be expanded in cooperation with an O-ring seal 205 disposed in a groove 206 and thence clamped with the clamps 202 may be advantageously used to effect a long term, leak-free coupling.

The aforementioned configuration permits any of the tubing sections 198 to be replaced independently of the other. The inside diameter of the tubing 198 may be varied to affect the output of the pump 152 without changing any other components of the entire system. In this manner, the same motor 150, transmission 151, and pump 152 can be used in a variety of varying output devices, minimizing the changes necessary to produce a range of pump assemblies 22 of varying paint output. This configuration also permits the pump head tube 198 to be fabricated from a more durable material than the other tubing 24 such that the pump head tube 198 can withstand the repeated collapsing and expanding caused by the peristaltic pumping head 186.

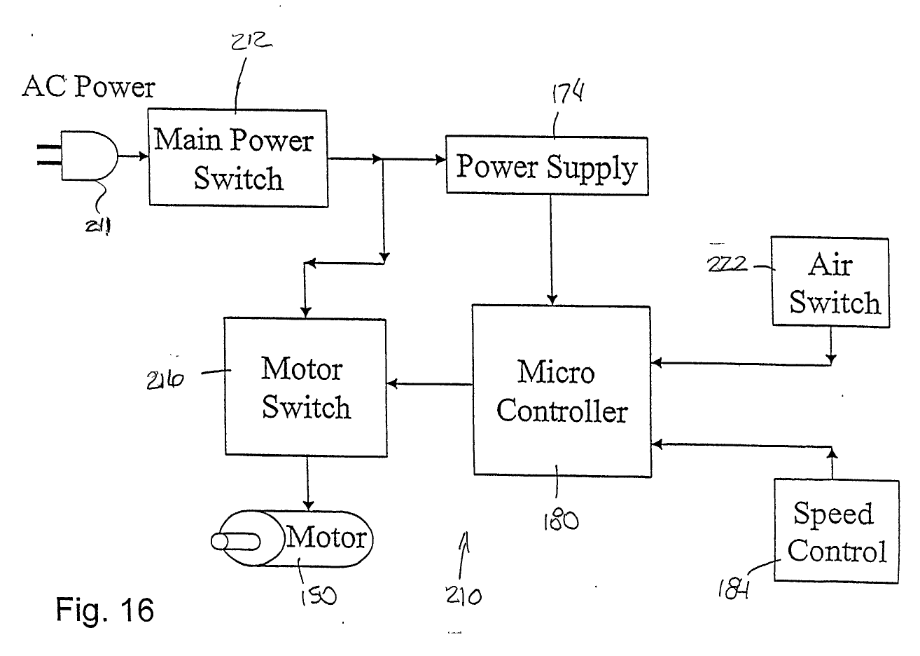

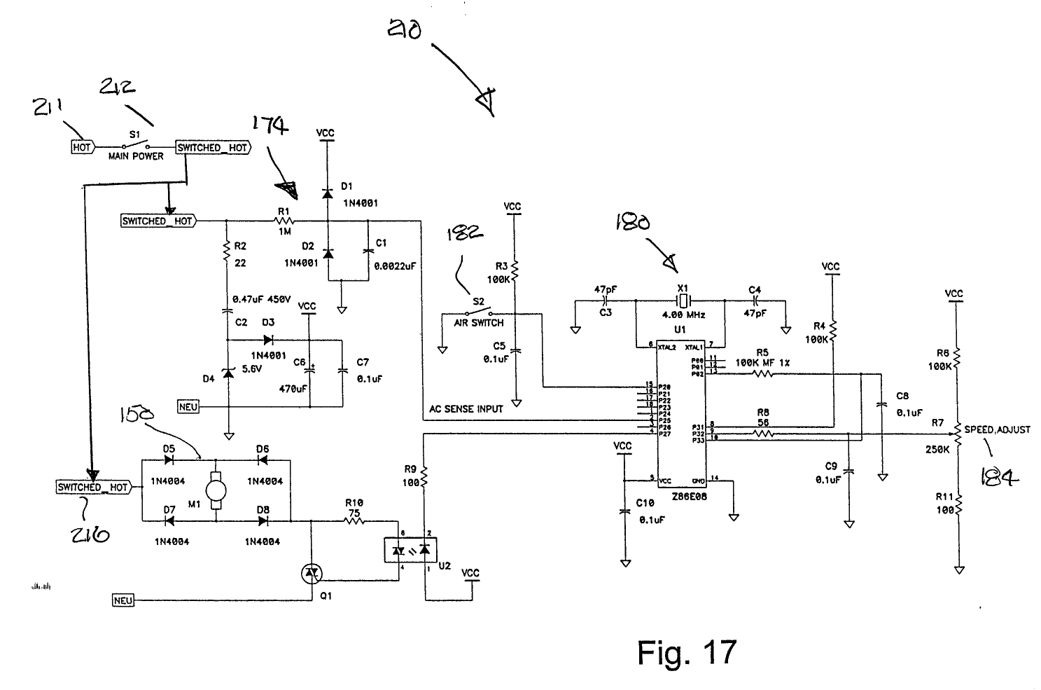

The pump assembly 22 also includes a control system such as is schematically illustrated in FIGS. 16 and 17. The control system 210 receives power via a common plug and cord 211 from an alternating power source, such as a common electric outlet . Delivery of the power to the control system 210 is controlled by a main power switch 212. The main power switch 212 is connected to the motor 150 with a motor switch 216. The main power switch 212 is also operably connected to a power supply 214, which is operably connected to a micro controller 220. The micro controller 220 receives input from an air switch (the air signal receiver) 222 and a speed control 224. Based on this input, the micro controller 220 controls the operation of the motor 150 by the motor switch 216.

Another aspect of the present invention relates to the control mechanism 210 for operating the paint applicator 10. The control mechanism has two modes of operation. Depressing the activation button 134 for at least a selected short period of time, preferably .6 second, activates the first mode. In the first mode, the paint applicator 10 remains activated until the activation button 134 is released. The first mode is preferably used when applying paint. A desired amount of paint is continually fed through the device and then the paint is spread over the surface as long as the activation button 134 is depressed. This is a press and hold mode of operation. Paint flow ceases when the activation button 134 is released. When more paint is needed, the process is repeated.

Depressing and releasing the activation button 134 such that the activation button 134 is depressed for less than the selected short period of time, preferably about one second, activates the second mode. More preferably, the selected short period of time is between 500 msecs and 1.0 sec in duration, and is most preferably substantially 600 msecs in duration. In the second mode, the paint applicator 10 remains activated until the activation button 134 is depressed a second time for any selected relatively short time period. This is a press to activate, press to deactivate mode of operation. The second mode is primarily used when cleaning the paint applicator 10 as the second mode allows water or other solvent to be fed through the paint applicator 10 when the paint applicator 10 is in a self-cleaning mode of operation. The operator should observe the self-cleaning operation and, once the cleaning process is completed, the activation button 134 is depressed to turn off the paint applicator 10.

As an initial step the pump assembly 22 is connected to an electrical power source and the main power switch 12 is turned on. Next, the air signal generator 133 of the flow control mechanism 132 is depressed to cause air to be forced through air tube 135 to engage the air signal receiver 222 in the pump base 22. Activation of the air signal receiver 222 thereby causes the motor to run and pump paint from the paint container to the roller assembly 20.

The air signal generator 133 of the flow control mechanism 132 is depressed which causes the pump assembly 22 to pump a desired amount of paint from the paint container to the roller assembly 20. After passing through the handle portion 34 and the arm portion 30, the paint flows through the apertures 60 and into the roller core 32. The paint then flows through the elongated apertures 86 in the roller core 32 and into the paint applicator 82.

The roller assembly 20 is moved with respect to a surface so that the paint applicator 82 rolls along the surface. Rolling of the paint applicator 82 along the surface thereby causes paint to be applied to the surface. Continuing to roll the paint applicator 82 over the surface causes the paint to be distributed over the surface until a desired thickness of the paint covers a desired portion of the surface.

Occasionally, it is necessary to depress the flow control mechanism 132 so that additional paint flows to the paint applicator 82. The process is repeated until the desired portion of the surface is painted or until the end of the workday. Thereafter, it is necessary to clean substantially all of the paint from the paint applicator 10. Cleaning of the paint applicator 10 prevents fouling of the components by paint accumulating therein. Cleaning of the paint applicator 10 also permits different colors of paint to be used in the paint applicator 10 without contamination associated with mixing of the different paint colors.

To facilitate cleaning of the paint applicator 10, the feed line 26 is removed from the paint container and then placed in a container that contains cleaning solution. The particular cleaning solution is selected based upon the type of paint used in the paint applicator. For water based type paints, the cleaning solution is preferably water used alone or with an additional cleaning agent that is mixed with the water. The pump assembly 22 is operated to pump the cleaning solution through the components of the paint applicator for a sufficient time such that substantially all of the paint is removed from the paint applicator 10.

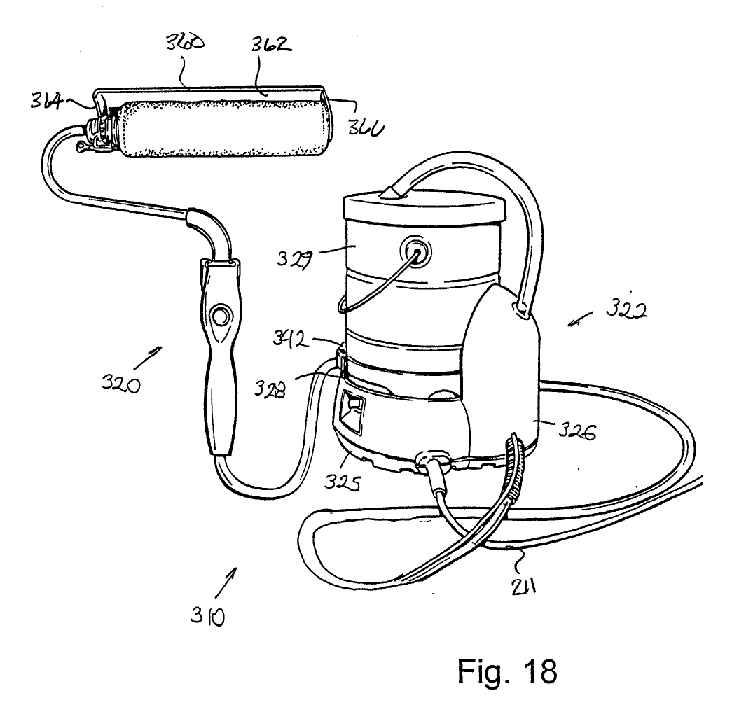

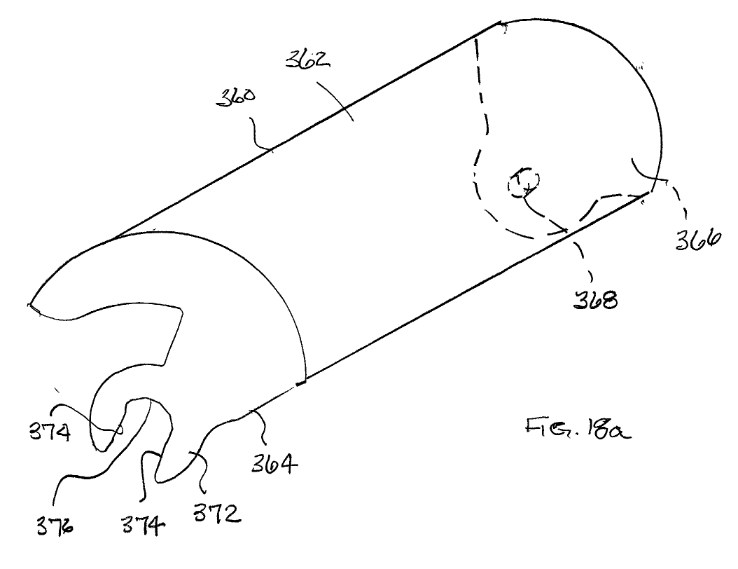

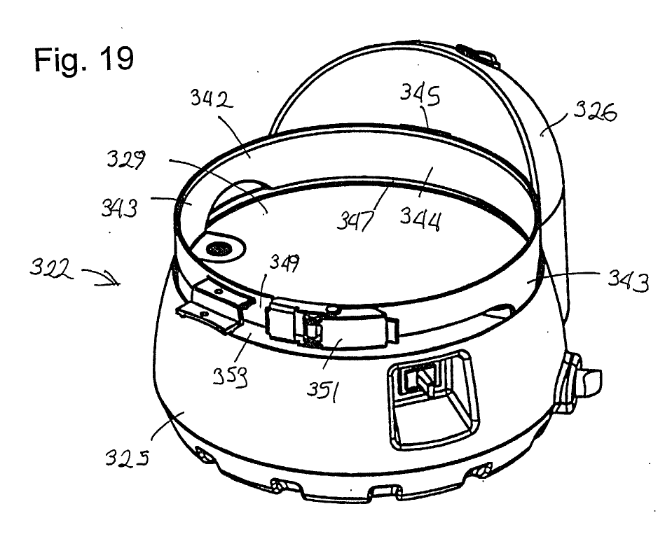

An alternative embodiment of the paint applicator 310 includes a roller assembly 320 and a pump assembly 322, as illustrated in FIGS. 18, 18a, and 19. The roller assembly 320 used in conjunction with this embodiment is preferably substantially the same of the roller assembly 20 used in conjunction with the embodiment illustrated in FIG. 1.

The pump assembly 322 includes a pump housing 325 and a side support 326 that extends from the pump housing 325. The pump housing 325 includes a substantially circular top surface 328 that is adapted to receive a paint container 329.

Extending around the top surface 328 is a strap 342 that maintains the paint container 329 in a fixed position with respect to the pump assembly 322. Side portions 343 of the strap 342 are preferably fixedly attached to the pump assembly 322 with screws. A back portion 344 of the strap 342 includes a tab 345 that at least partially extends into the pump assembly 322. Attachment of the back portion 344 to the pump assembly 322 with the tab 345 allows the strap 342 to constrict to fasten the strap 342 around the paint container. The back portion 344 is spaced a distance above the flat top surface 340 to provide a back channel 347 into which a bottom lip of the paint container 329 can seat.

A front portion 349 of the strap 342 includes a buckle 351 that is movable between an open position and a closed position. The buckle 351 preferably has an over center configuration. The buckle 351 is preferably spring loaded such that the buckle 351 permits expansion to accommodate different sizes of paint containers to be used with the paint applicator 310 of the present invention.

The front portion 349 is spaced a distance above the flat top surface 340 to provide a front channel 353 into which a bottom lip of the paint container 329 can seat. Seating of the bottom lip of the paint container in the back channel 347 and the front channel 353 and then moving the buckle to the closed position fastens the paint container on the pump assembly 322 and thereby enables the pump assembly 322 to be lifted as a unit with the paint container using the handle on the paint container 329.

A roller cover 360 includes a semi-circular cover portion 362 and ends 364, 366. The cover 360 is preferably formed of a resilient plastic material. The cover 360 is designed to be a quick release type so that the cover 360 can be quickly engaged to and disengaged from the roller assembly 320. Accordingly, the end 366 includes an inwardly directed post 368. The post is designed to be received within the aperture 370 (see FIG. 2). The end 364 includes an arm 372 having slightly tapered ramps 374 with a semi-circular receive 376 defined at the inward terminus of the ramps 374. The radius of the receiver 376 is slightly greater than the circumferential groove 378, depicted in FIG. 2. In assembly, the post is inserted in the aperture 370 and the ramps are forced onto the groove 378. This latter action acts to spread the ramps 374 slightly, thereby admitting the receiver 376 into engagement with the groove 378. After the groove 378 passes through the ramps 374, the resilient nature of the material forming the cover 360 acts to cause the ramps 374 to close slightly, thereby trapping the groove 378 in the receiver 376. Once so engaged, the cover 360 is coupled to the roller assembly 320. To disengage the cover 360 from the roller assembly 320, the opposite action is applied. Pulling on the cover 320 will again slightly spread the ramps 374 to allow the groove 378 to disengage from the receiver 376 and pass outward through the ramps 374.

The components of this embodiment of the paint applicator 310 that are not indicated as being different from the embodiment of the paint applicator 10 illustrated in FIG. 1 are preferably substantially the same as the paint applicator 10 illustrated in FIG. 1.

The paint applicator 310 of this embodiment is preferably operated in a manner that is substantially similar to the manner in which the paint applicator 10 illustrated in FIG. 1 is operated.

A limitation of paint spreaders such as depicted in FIG. 1 is that it is very difficult to apply in the corner at the juncture of two walls. To solve this problem, a corner paint applicator 400 is disclosed. While the corner applicator 400 is described with reference to the paint applicator of the present invention, it should be noted that the use of the corner applicator 400 is not confined to the paint applicator of the present invention and may find wide use with other paint applicators of various types. Specifically, the paint applicator may be used with a handle that does not supply a flow of paint. In this instance, the corner paint applicator 400 may be immersed in paint to renew the paint on the corner paint applicator 400 for application to a surface.

The corner applicator 400 may be used with a truncated arm portion 30 as depicted in FIG. 2. To effect the truncated arm portion 30, a cut 406 is made in the tube. The truncated arm portion 30 may then be straightened by increasing the angle alpha to substantially 180°. Making the cut 406 exposes an open end in the main section 52. The opened end of the truncated arm portion 30 may then be inserted into the holder 408 of the paint applicator body 402 for supplying a flow of paint to the paint applicator 400.

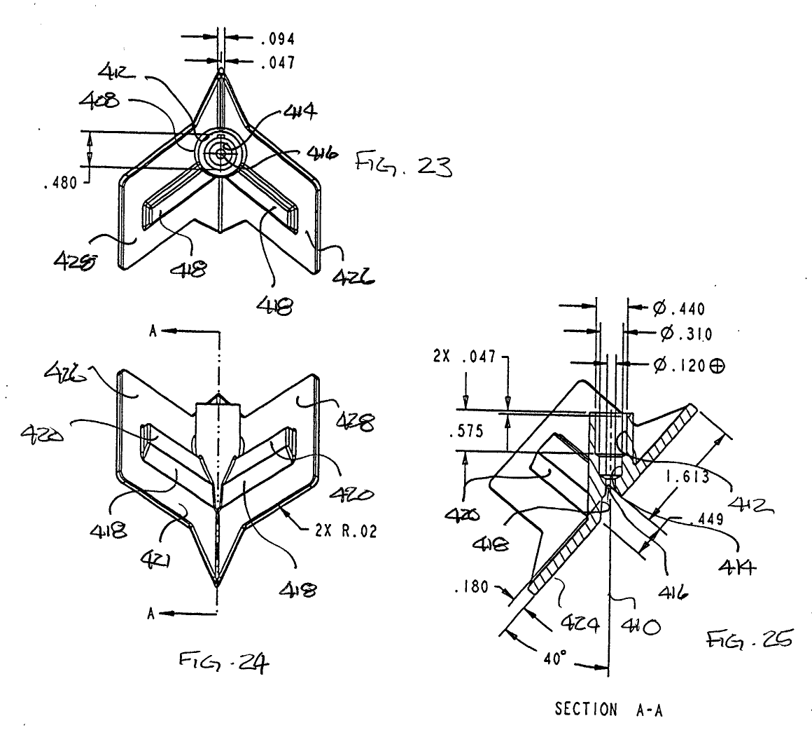

The holder 408 has a generally cylindrical outside diameter having a constant radius along the longitudinal axis 410. As depicted in FIG. 25, the longitudinal axis 410 of the holder 408 intersects the plane of the pad support surface 424 at an angle between 20 and 70° and most preferably at an angle of 40°, as depicted in FIG. 25.

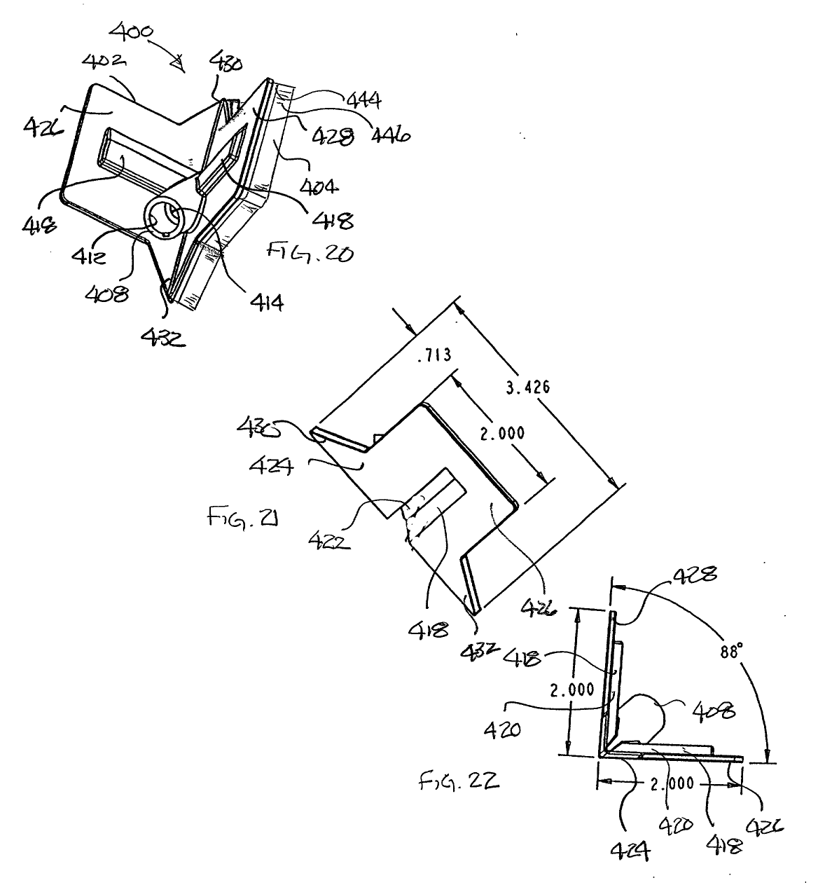

The holder 408 has a first inside diameter 412 that is only slighter greater than the outside diameter of the main section 52 of the truncated arm portion 30 in order to establish friction fit when the main section 52 is inserted into the first inside diameter 412. The second inside diameter 414 is significantly less than the first inside diameter 412 and provides a paint passageway to a nozzle 416. The nozzle 416 is in fluid communication with a pair of outwardly directed paint channels 418. The paint channels 418 are formed by channel walls 420 that project rearward from the rear margin 421 of the paid support surface 424 as depicted in FIGS. 20, 23, and 24. In this manner, a recessed channel 422 (see FIGS. 21 and 25) is formed intersecting the pad support surface 424. The pad support surface 424 has two joined wings 426, 428. As depicted in FIG. 22, the wings 426, 428 are joined at an angle that is slightly less than 90° and may be between 75 and 90° and is most preferably 88°.

The paid support surface 424 further includes an upper point 430 extending upward from the juncture of the wings 426, 428 and an oppositely directed lower point 432 extending downward from the juncture of the wings 426, 428. Each of the points 430, 432 has two smaller triangular wings, the smaller wings of the respective points 430, 432 being disposed relative to each other at the same interior angle as the wings 426, 428. The points 430, 432 are useful, for example, in painting in small crevasses and the like.

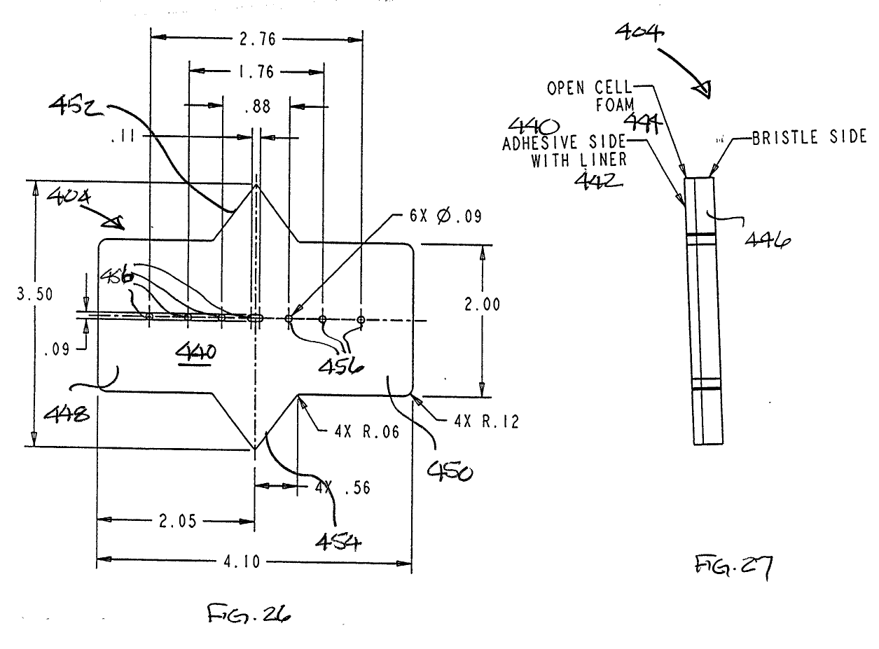

The paint applicator pad 404 is depicted in FIGS. 20, 26, and 27. The pad 404 has an adhesive side 440, as depicted in FIG. 27. The pad 404 is designed to be replaceable on the body 402. Accordingly, when a user first receives a paid 404, a release liner 442 overlies the adhesive on the adhesive side 440. The release liner 442 may be peeled away from the adhesive and the pad 404 pressed into engagement with the pad support surface 424, the adhesive side 440 being brought into contact with the pad support surface 424.

The adhesive is applied to a first side of an open cell foam layer 444. The opposing side of the open cell foam layer 444 supports a plurality of bristles 446.

The paint applicator pad 404 is cut to mirror the pad support surface 424. Accordingly, the pad 404 has wings 448, 450 joined at a juncture, as well as an upper point 452 and a lower point 454. A plurality of paint apertures 456 extend in a line along a transverse axis of the pad 404.

In operation, when the paid 404 is adhered to the body 402, the paint apertures 456 overlie and are in registry with the two paint channels 418. Paint flowing to the paint applicator 400 passes through the second inside diameter 414 of the holder 408 and out through the nozzle 416 to flood the paint channels 418. The paint is then distributed by means of the paint apertures 456 to the entire layer of bristles 446 for application to two wall surfaces joined at a corner substantially simultaneously.

It is contemplated that features disclosed in this application, as well as those described in the above applications incorporated by reference, can be mixed and matched to suit particular circumstances. Various other modifications and changes will be apparent to those of ordinary skill.

1. A paint applicator for use in spreading paint over a surface, the paint applicator comprising:
a roller assembly comprising:
a handle portion that is suitable for holding by a user;
an arm portion extending from the handle portion; and
a roller core removably attachable to the arm portion for rotation with respect to the arm portion, wherein the roller core is adapted to receive a paint applicator thereover;
tubing having a central passage extending therethrough; and
a pump assembly comprising:
a pump that conveys paint through the tubing to the roller assembly; and
a paint container support surface positioned at least partially above the pump so that a central axis of the pump assembly is proximate to a central axis of a paint container placed on the paint container support surface.

2. The paint applicator of claim 1, and further comprising at least one locking mechanism that removably and rotatably attaches the roller core to the arm portion.

3. The paint applicator of claim 2, wherein each of the locking mechanisms comprises a central section, a top section, an engagement section, and an activation section, wherein the central section is attached to the arm portion, wherein the top section is attached to the central section opposite the arm portion, wherein the engagement section and the activation section are attached to opposite ends of the top section, wherein the arm portion has a channel formed therearound, and wherein the channel is adapted to receive the engagement section.

4. The paint applicator of claim 1, and further comprising at least one locking mechanism that removably attaches the arm portion to the handle portion.

5. The paint applicator of claim 4, wherein each of the locking mechanisms comprises a central section, a top section, an engagement section, and an activation section, wherein the central section is attached to the arm portion, wherein the top section is attached to the central section opposite the arm portion, wherein the engagement section and the activation section are attached to opposite ends of the top section, wherein the arm portion has a channel formed therearound, and wherein the channel is adapted to receive the engagement section.

6. The paint applicator of claim 1, wherein the roller core has a first core portion and a second core portion that releasably engage each other to retain the paint applicator thereon.

7. The paint applicator of claim 1, wherein the handle portion has a system activation control therein, wherein the system activation control has a first mode and a second mode, wherein the system activation control remains activated when depressed for a first period of time, and wherein the system activation control deactivates after release when activated for a second period of time that is longer than the first period of time.

8. The paint applicator of claim 1, wherein the pump assembly has a peristaltic pumping mechanism that is adapted to receive the tubing.

9. A paint applicator for application of paint over a surface, the paint applicator comprising:
a handle portion that is suitable for holding by a user;
an arm portion removably attached to the handle portion;
a roller core rotatably and removably attached to the arm portion;
a paint applicator removably attached to the roller core, wherein the arm portion, the roller core and the paint applicator are operably attached to the handle portion to deliver paint from the handle portion to the paint applicator;
a pump assembly comprising:
a pump mounted therein;
a paint container support surface; and
a retaining strap mounted with respect to the paint container support surface so that the retaining strap is capable of extending around a paint container placed on the paint container support surface to retain the paint container on the paint container support surface; and
tubing operably connected to the pump for delivering paint from a paint container to the handle portion.

10. The paint applicator of claim 9, and further comprising at least one locking mechanism that removably and rotatably attaches the roller core to the arm portion.

11. The paint applicator of claim 10, wherein each of the locking mechanisms comprises a central section, a top section, an engagement section, and an activation section, wherein the central section is attached to the arm portion, wherein the top section is attached to the central section opposite the arm portion, wherein the engagement section and the activation section are attached to opposite ends of the top section, wherein the arm portion has a channel formed therearound, and wherein the channel is adapted to receive the engagement section.

12. The paint applicator of claim 9, herein the roller core has a first core portion and a second core portion that releasably engage each other to retain the paint applicator thereon.

13. The paint applicator of claim 9, and further comprising at least one locking mechanism that removably attaches the arm portion to the handle portion.

14. The paint applicator of claim 12, wherein each of the locking mechanisms comprises a central section, a top section, an engagement section, and an activation section, wherein the central section is attached to the arm portion, wherein the top section is attached to the central section opposite the arm portion, wherein the engagement section and the activation section are attached to opposite ends of the top section, wherein the arm portion has a channel formed therearound, and wherein the channel is adapted to receive the engagement section.

15. The paint applicator of claim 9, wherein the handle portion has a system activation control therein, wherein the system activation control has a first mode and a second mode, wherein the system activation control remains activated when depressed for a first period of time, and wherein the system activation control deactivates after release when activated for a second period of time that is longer than the first period of time.

16. A method of using a paint applicator, the method comprising:
operably connecting a roller assembly to a pump assembly with tubing, wherein the pump assembly has a feed line extending therefrom;
operably connecting the feed line to a paint source;
activating the pump assembly for a first period of time by depressing a button that is operably connected to the pump assembly, wherein the pump assembly causes paint to be passed through the pump assembly and the tubing to the roller assembly, wherein the pump assembly remains activated when the button is released;
activating the pump assembly for a second period of time that is greater than the first period of time by depressing the button, wherein the pump assembly deactivates when the button is released; and
rolling the roller assembly along a surface to at least partially cover the surface with the paint.

17. The method of claim 16, and further comprising removably attaching a roller core to the roller assembly.

18. The method of claim 17, wherein the roller core is removably attached to the roller assembly with at least one locking mechanism, wherein each of the locking mechanisms comprises a central section, a top section, an engagement section, and an activation section, wherein the central section is attached to the arm portion, wherein the top section is attached to the central section opposite the arm portion, wherein the engagement section and the activation section are attached to opposite ends of the top section, wherein the arm portion has a channel formed therearound, and wherein the channel is adapted to receive the engagement section.

19. A method of cleaning a paint applicator, the method comprising:
operably connecting a roller assembly to a pump assembly with tubing, wherein the pump assembly has a feed line extending therefrom;
operably connecting the feed line to a cleaning solution;
activating the pump assembly for a first period of time by depressing a button that is operably connected to the pump assembly, wherein the pump assembly causes cleaning solution to be passed through the pump assembly, the roller assembly and the tubing to affect cleaning of the pump assembly, the roller assembly and the tubing assembly, wherein the pump assembly remains activated when the button is released; and
activating the pump assembly for a second period of time that is longer that the first period of time by depressing the button, wherein the pump assembly deactivates when the button is released.

20. The method of claim 19, and further comprising removably attaching a roller core to the roller assembly.

21. The method of claim 19, wherein the roller core is removably attached to the roller assembly with at least one locking mechanism, wherein each of the locking mechanisms comprises a central section, a top section, an engagement section, and an activation section, wherein the central section is attached to the arm portion, wherein the top section is attached to the central section opposite the arm portion, wherein the engagement section and the activation section are attached to opposite ends of the top section, wherein the arm portion has a channel formed therearound, and wherein the channel is adapted to receive the engagement section.

22. The method of claim 19, and further comprising removably attaching a handle portion to the roller assembly.

23. A roller assembly for use with a paint applicator device, the roller assembly comprising:
a roller being satuatable with paint for direct application to a surface, the roller having a tubular aperture defined therein;
a distribution section disposable within the roller aperture and spaced apart therefrom to define an annular channel between the distribution section and the roller; and
a roller core being disposable in the annular channel, the roller core having a plurality of elongate apertures radially displaced thereon, a ridge being disposed between adjacent elongate apertures.

24. The roller assembly of claim 23, wherein the roller core has a central tube member having the plurality of elongate apertures defined therein, a distal end cap presenting an outside margin for sealingly engaging an inside diameter of the roller, a proximal roller cap presenting an outside margin for sealingly engaging an inside diameter of the roller is disposed opposite the end cap.

25. The roller assembly of claim 24, wherein the roller cap of the roller core has a plurality of flexible, resilient pins extending outwardly therefrom, the plurality of pins for engaging the roller.

26. The roller assembly of claim 25, wherein each of the roller core pins engage a respective flat defined on the roller.

27. The roller assembly of claim 23, wherein the distribution section includes an elongate metallic tube having a proximal end and an opposed distal end, a plurality of apertures being defined in the tube, the apertures increasing in diameter from the proximal end to the distal end.

28. The roller assembly of claim 23, wherein the roller includes an O-ring disposed on an inner diameter, the O-ring for sealing engagement with the tube member of the roller core.

29. The roller assembly of claim 28, wherein the tube member of the roller core has two bearing surfaces, a first bearing surface having a first diameter and a second bearing surface having a second diameter that is greater than the first diameter, the O-ring being passable over the first bearing surface to compressively, sealingly engage the second bearing surface.

30. The roller assembly of claim 29, wherein the tube member of the roller core has at least one profiled bearing surface, the profiled bearing surface opposing rotation of the roller relative to the roller core when the roller is in engagement with the profiled bearing surface.

31. A pump assembly for use with a paint applicator device, the pump assembly for selectively engaging a paint container, the pump assembly comprising:
a floor for supporting the paint container;
a curved back extending upward from the floor; and
a strap for selective retention of the paint container, the strap being anchored to the floor and the back.

32. The pump assembly of claim 31, wherein the strap is anchored to the back by a slidable engaging member to accommodate paint containers having a range of varying circumferential dimensions.

33. The pump assembly of claim 31, wherein the strap is spaced apart from the floor adjacent to the back and presents a lower margin, the strap lower margin being engageable with a lip defined on the paint container.

34. The pump assembly of claim 31, wherein the strap includes a first strap portion and a second strap portion, the first and second strap portions being joinable by a clamp, the clamp being variable in length to vary the length of the strap.

35. The pump assembly of claim 34, wherein the strap clamp includes a spring, the spring being elongatable vary the length of the clamp.

36. The pump assembly of claim 35, wherein the strap clamp includes an over center locking member, the spring being elongatable to ease the force required to force the locking member over center.

37. A pump assembly motor unit for use with a paint applicator device, the motor being operably coupled to a peristaltic pump, the pump assembly comprising:
an electric motor;
a planetary gear train operably coupled to the motor and to the peristaltic pump; and
a pump housing for housing the electric motor and the planetary gear train.

38. The pump assembly motor unit of claim 37, wherein the pump assembly motor unit is disposed substantially underlying a floor, the floor for selectively supporting a paint container.

39. The pump assembly motor unit of claim 37, wherein the pump assembly motor unit has a longitudinal axis and is disposed in an inline configuration coincident with the longitudinal axis, an axial screen substantially eliminating axial loading on the motor.

40. The pump assembly motor unit of claim 37, wherein the motor is a permanent magnet type motor.

41. The pump assembly motor unit of claim 37, wherein the gear train is formed of a plastic material.

42. The pump assembly motor unit of claim 37, wherein the gear train includes a plurality of planetary gear carriers for torque amplification of the motor torque.

43. The pump assembly motor unit of claim 42, wherein the gear train includes three planetary gear carriers.

44. The pump assembly motor unit of claim 42, wherein each of the planetary gear carriers is substantially identical being comprised of common components.

45. The pump assembly motor unit of claim 37, wherein the pump housing is an integral unitary member, the unitary member acting to minimize misalignment in the motor and gear train.

46. The pump assembly motor unit of claim 45, wherein the pump housing includes a fastener that engages a last planetary gear carrier to minimize thrust effects of the peristaltic pump on the gear train and motor.

47. The pump assembly motor unit of claim 46, wherein the last planetary gear carrier includes a an output shaft, the output shaft being keyed to a receiving aperture of the peristaltic pump for imparting rotary motion to the peristaltic pump.

48. The pump assembly motor unit of claim 47, wherein the last planetary gear carrier output shaft is spaced apart from the receiving aperture by a certain dimension for isolating the gear train from axial bearing loads of the peristaltic pump.

49. A control system for use in a pump assembly motor unit, the pump assembly having a motor unit, the control system comprising a processor being operably communicatively coupled to the motor unit for controlling the motor unit, the processor effecting variable motor speed to vary pressure through a fixed orifice.

50. The control system of claim 49, having a certain program time and being operably communicatively coupled to a manually actuatable controller, the processor latching the motor unit in an operating mode when the controller sees continuity at the controller for less than the program time, the processor latching the motor unit in a non-operating mode when the controller sees continuity at the controller a second time

51. The control system of claim 50, wherein the processor holds the motor unit in an operating mode when the processor sees controller continuity that exceeds the program time and maintains the motor unit in the operating mode for the duration of such continuity.

52. A paint applicator comprising:
an applicator assembly for applying paint to an object;
a pump assembly being in fluid communication with the applicator assembly and having a permanent magnet DC motor operably coupled to a transmission, the transmission operably coupled to a peristaltic pump, the pump assembly being in fluid communication with a paint reservoir.

53. The paint applicator of claim 52, the transmission having at least one set of planetary gears.

54. The paint applicator of claim 52, the transmission having between one and three sets of planetary gears.

55. The paint applicator of claim 52, the permanent magnet DC motor having a substantially axial cooling air flow path, cooling air entering a motor housing at a first motor end and being exhausted from the housing at a point proximate a second end of the motor housing, a cover interposing a baffle between the first end and the point of exhausting the cooling air from the housing.

56. The paint applicator of claim 55 including an end plate being fixedly coupled to the motor housing at the first motor end, the end plate defining at least in part radial cooling air channels.

57. The paint applicator of claim 55, the cover having an open end for exhausting the cooling air therefrom.

58. The paint applicator of claim 52, the pump assembly being in fluid communication with the applicator by means of a first vinyl tubing and the pump assembly being in fluid communication with the paint reservoir by means of a second vinyl tubing, the first and second vinyl tubing being sealably coupled to the pump assembly by at least one O-ring seal being interposed between a respective tubing inside diameter and the pump assembly.

59. The paint applicator of claim 52, the applicator assembly having a handle, the handle being releasably couplable to an arm and including a locking mechanism, the locking mechanism being hingedly coupled to a handle component and having an engagement section for selectively engaging an arm flange.

60. The paint applicator of claim 59, the locking mechanism being formed integral with the handle component.

61. The paint applicator of claim 60, the locking mechanism being formed of a plastic material and being molded integral with the handle component.

62. The paint applicator of claim 59, rotation of the locking mechanism about a hinge acting to disengage the handle from the arm.

63. The paint applicator of claim 62, the locking mechanism hinge biasing the locking mechanism into locking engagement with the arm.

64. The paint applicator of claim 52 including a strap for securing the paint reservoir to the pump assembly, the strap overlying a reservoir bottom lip.

65. The paint applicator of claim 64, the strap for securing the paint reservoir to the pump assembly being coupled in part to the pump assembly by a shiftable tab, the tab accommodating constriction of the strap for securing plurality of paint reservoirs of varying size.

66. The paint applicator of claim 65, the strap having an over center buckle.

67. The paint applicator of claim 66, the strap over center buckle including an extensible link.

68. The paint applicator of claim 67, the buckle extensible link being biased in a least extended disposition.

69. The paint applicator of claim 52 including a paint roller, a semi-circular cover being couplable to the paint roller, the cover being quick releasable from the paint roller.

70. The paint applicator of claim 69 including a first engaging device, the first engaging device being snap engageable to a groove defined adjacent to a paint roller first end.

71. The paint applicator of claim 70 the first engaging device having a semi-circular receiver, the receiver for engaging the groove.

72. The paint applicator of claim 70 including a second engaging device, the second engaging device being a post disposable in an aperture defined proximate a paint roller second end.

73. The paint applicator of claim 52 including a roller core for supporting a paint roller, the roller core having an axial passageway defined by a plurality of passage elements.

74. The paint applicator of claim 73 including a plurality of elongate slots, a slot being defined between adjacent passage elements.

75. The paint applicator of claim 74, the passage elements having a substantial volume to displace volume that otherwise would be flooded with paint.

76. The paint applicator of claim 75, the passage elements being formed hollow with a sealed interior space.

77. The paint applicator of claim 73, including a tubular distribution section, the distribution section being disposable in the axial passage and having a plurality of paint distribution apertures arrayed along a longitudinal axis.

78. The paint applicator of claim 77, the paint distribution apertures being arrayed such that the least diameter aperture is disposed proximate a proximal end of the distribution section and increasing in diameter toward a distal end of the distribution section.

79. The paint applicator of claim 78, the paint distribution apertures being arrayed such that the least diameter aperture is disposed proximate a proximal end of the distribution section and increasing in diameter toward a distal end of the distribution section, excepting the distalmost aperture.

80. The paint applicator of claim 79, the distalmost aperture being substantially the same diameter as the proximalmost aperture.

81. The paint applicator of claim 52 including a corner applicator having a paint applicator pad removably conformably adhered to a paint applicator body, the body having two wings joined at a juncture, the wings defining an interior angle relative to each other of less than 90 degrees.

82. The paint applicator of claim 81 wherein the wing interior angle is less than 90 degrees and more than 75 degrees.

83. The paint applicator of claim 82 wherein the wing interior angle is substantially 88 degrees.

84. The paint applicator of claim 81 including a first point being outwardly from the juncture of the wings, the point being formed of two smaller point wings, the two smaller point wings being disposed relative to each other at the interior angle of the wings.

85. The paint applicator of claim 84 including a second point being outwardly from the juncture of the wings and opposed to the first point, the point being formed of two smaller point wings, the two smaller point wings being disposed relative to each other at the interior angle of the wings.

86. The paint applicator of claim 81, the paint applicator body having a holder being integral with the wings, the holder being matable with a handle for supporting the paint applicator body.

87. The paint applicator of claim 81, the holder having a passageway that is fluidly communicable with the handle and is in fluid communication with the paint applicator pad.

88. The paint applicator of claim 81, the paint applicator body having at least one paint channel defined therein, the at least one paint channel being in fluid communication with the passageway and with the paint applicator pad.

89. The paint applicator of claim 81, the paint applicator body having at least one aperture defined therethrough, the al least one aperture being in fluid communication with a pad application layer.

90. The paint applicator of claim 89, the application layer being formed of a plurality of bristles.

91. The paint applicator of claim 89, the at least one aperture overlying the at least one channel when the paint applicator pad is disposed on the paint applicator body.

92. The paint applicator of claim 89, the application layer being adhered to an open cell foam layer.

93. A corner paint applicator having a paint applicator pad removably conformably adhered to a paint applicator body, the body having two wings joined at a juncture, the wings defining an interior angle relative to each other of less than 90 degrees.

94. The paint applicator of claim 93 wherein the wing interior angle is less than 90 degrees and more than 75 degrees.

95. The paint applicator of claim 94 wherein the wing interior angle is substantially 88 degrees.

96. The paint applicator of claim 93 including a first point being outwardly from the juncture of the wings, the point being formed of two smaller point wings, the two smaller point wings being disposed relative to each other at the interior angle of the wings.

97. The paint applicator of claim 96 including a second point being outwardly from the juncture of the wings and opposed to the first point, the point being formed of two smaller point wings, the two smaller point wings being disposed relative to each other at the interior angle of the wings.

98. The paint applicator of claim 93, the paint applicator body having a holder being integral with the wings, the holder being matable with a handle for supporting the paint applicator body.

99. The paint applicator of claim 93, the holder having a passageway that is fluidly communicable with the handle and is in fluid communication with the paint applicator pad.

100. The paint applicator of claim 93, the paint applicator body having at least one paint channel defined therein, the at least one paint channel being in fluid communication with the passageway and with the paint applicator pad.

101. The paint applicator of claim 93, the paint applicator body having at least one aperture defined therethrough, the al least one aperture being in fluid communication with a pad application layer.

102. The paint applicator of claim 101, the application layer being formed of a plurality of bristles.

103. The paint applicator of claim 101, the at least one aperture overlying the at least one channel when the paint applicator pad is disposed on the paint applicator body.

104. The paint applicator of claim 101, the application layer being adhered to an open cell foam layer.
